(19) United States
(12) Patent Application Publication
(10) Pub. No.: US 2025/0335948 A1
(43) Pub. Date: Oct. 30, 2025

(54) DYNAMIC PRICING SYSTEM FOR DETERMINING PRICE OF PARKING PERMIT BASED ON DEEP LEARNING

(71) Applicant: grovy Inc., Seoul (KR)

(72) Inventors: Misung CHO, Seoul (KR); Ahyoung SHIN, Goyang-si (KR); Byungkwan JUNG, Seoul (KR); Sunwoo JIN, Yongin-si (KR); Youngjin Han, Seoul (KR)

(21) Appl. No.: 18/731,262

(22) Filed: Jun. 1, 2024

(30) Foreign Application Priority Data
Apr. 29, 2024 (KR) 1 0-2024-0057046

(51) Int. Cl. G06Q 30/0201

(52) U.S. Cl. CPC G06Q 30/0206

(57) ABSTRACT

The present invention provides a dynamic pricing system that determines a price of a parking permit on the basis of deep learning. The present invention is a technology developed through the Development of Artificial Intelligence Dynamic Pricing Solution for Smart Mobility Services, a project CY230022 funded by the Seoul Business Agency (2023 Artificial Intelligence Technology Commercialization Support Project). A data collection unit may collect data to determine the price of the parking permit, a pricing unit may determine the price of the parking permit from the data using a Markov Decision Process (MDP) algorithm, a memory may store instructions to operate the data collection unit and the pricing unit, and a processor may execute the instructions stored in the memory to operate the data collection unit and the pricing unit.

### CROSS REFERENCE TO RELATED APPLICATION

The present application claims priority to Korean Patent Application No. 10-2024-0057046, filed on Apr. 29, 2024, the disclosure of which is incorporated by reference herein in its entirety.

### BACKGROUND OF THE INVENTION

### Field of the Invention

The present invention relates to a dynamic pricing system for determining a price of a parking pass based on deep learning.

### Description of the Related Art

In modern cities, parking issues are constantly increasing, and the resulting congestion levels and poor efficiency are becoming an inevitable phenomenon. In particular, existing parking lots use flat-rate pricing, which causes users the inconvenience of having to pay a fixed parking fee regardless of the surrounding conditions. The flat-rate parking fee system fails to take into consideration the diversity of parking supply and demand, which burdens the users and makes it difficult for parking operators to maximize revenue.

The present invention is a technology developed through the Development of Artificial Intelligence Dynamic Pricing Solution for Smart Mobility Services, a project CY230022 funded by the Seoul Business Agency (2023 Artificial Intelligence Technology Commercialization Support Project).

### SUMMARY OF THE INVENTION

The present invention is directed to providing a dynamic pricing system based on a deep learning algorithm that dynamically determines a price of a parking permit according to changes in the surrounding environment.

The dynamic pricing system of the present invention may include a data collection unit, a pricing unit, a memory, and a processor. A data collection unit may collect data necessary to determine the price of the parking permit, a pricing unit may determine the price of the parking permit from the data using a Markov Decision Process (MDP) algorithm, a memory may store instructions to operate the data collection unit and the pricing unit, and a processor may execute the instructions stored in the memory to operate the data collection unit and the pricing unit. Further, the MDP algorithm may determine action information that represents an amount of change in the price of the parking permit on the basis of state information, which is specified by a combination of the number of unused parking permits, a parking lot occupancy rate, and a current time period. The pricing unit may determine the price of the parking permit by summing an amount of change in price specified by the action information determined by the MDP algorithm to a base price of the parking permit.

A dynamic pricing method of the present invention may include collecting data that includes information on the number of unused parking permits, a parking lot occupancy rate, and a current time period, necessary to determine a price of a parking permit; and determining the price of the parking permit from the data, using a Markov Decision Process (MDP) algorithm. Here, the MDP algorithm may determine action information that represents an amount of change in the price of the parking permit on the basis of state information, which is specified by a combination of the number of unused parking permits, the parking lot occupancy rate, and the current time period, and the price of the parking permit may be determined by summing an amount of change in price specified by the action information determined by the MDP algorithm to a base price of the parking permit.

The dynamic pricing system of the present invention may dynamically determine a price of a parking permit according to changes in the surrounding environment, on the basis of a Markov Decision Process (MDP) algorithm.

### BRIEF DESCRIPTION OF THE DRAWINGS

FIG. 1 is a block diagram for describing a dynamic pricing system of the present invention.

FIG. 2 is a block diagram for describing a training operation of the dynamic pricing system of the present invention.

FIG. 3 is a flowchart for describing the pricing operation of the dynamic pricing system.

FIG. 4 is a flowchart for describing a training operation of a pricing unit of the dynamic pricing system.

FIG. 5 is a block diagram illustrating a configuration of the dynamic pricing system according to an embodiment of the present invention.

### DETAILED DESCRIPTION OF THE INVENTION

The present invention may be variously modified and may have various embodiments, and particular embodiments illustrated in the drawings will be described in detail below. However, the description of the embodiments is not intended to limit the present invention to the particular embodiments, but it should be understood that the present invention is to cover all modifications, equivalents and alternatives falling within the spirit and technical scope of the present invention.

The terms such as “first” and “second” may be used to describe various constituent elements, but the constituent elements should not be limited by the terms. These terms are used only to distinguish one constituent element from another constituent element. For example, a first constituent element may be named a second constituent element, and similarly, the second constituent element may also be named the first constituent element, without departing from the scope of the present invention. The term “and/or” includes any and all combinations of a plurality of the related and listed items.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

The terminology used in the present application is used for the purpose of describing particular embodiments only and is not intended to limit the present invention. Singular expressions include plural expressions unless clearly described as different meanings in the context. In the present application, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

In this regard, such as “about”, “substantially”, and the like are used throughout the specification of the present application in the sense of “at, or nearly at, when given the manufacturing, design, and material tolerances inherent in the stated circumstances” and are used to prevent the unscrupulous infringer from unfairly taking advantage of the present disclosure where exact or absolute figures and operational or structural relationships are stated as an aid to understanding the present invention. Throughout the specification of the present invention, the term “step . . . ” or “step of . . . ” does not mean “step for . . . ”

In the present specification, the term ‘unit’ includes a unit realized by hardware, a unit realized by software, and a unit realized by using both software and hardware. In addition, one unit may be realized by using two or more hardware, and two or more units may be realized by using one hardware.

In the present specification, some of the operations or functions, which are described as being performed by a terminal, an apparatus, or a device, may be instead performed by a server connected to the terminal, the apparatus, or the device. Likewise, some of the operations or functions, which are described as being performed by a server, may be performed by a terminal, an apparatus, or a device that is connected to the server.

Unless otherwise defined, all terms used herein, including technical or scientific terms, have the same meaning as commonly understood by those skilled in the art to which the present invention pertains. The terms such as those defined in a commonly used dictionary should be interpreted as having meanings consistent with meanings in the context of related technologies and should not be interpreted as ideal or excessively formal meanings unless explicitly defined in the present application.

Hereinafter, an exemplary embodiment of the present invention will be described in detail with reference to the accompanying drawings. In describing the present invention, the same reference numerals are used for identical constituent elements in the drawings, and redundant descriptions of identical constituent elements are omitted in order to facilitate an overall understanding.

In major cities across the world, the demand on limited parking spaces in cities is increasing due to the rapid growth in the number of vehicles. The lack of parking spaces in cities causes urban environmental problems such as worsening air pollution according to increased fuel consumption along with traffic congestion levels, and it also has a negative effect on the daily lives of ordinary citizens, such as spending a lot of time to find a parking space.

A smart parking system, which has been actively researched in recent years, may efficiently manage parking spaces using a vehicle detection sensor, a data communication network, a data processing and analysis system, a user application that provides real-time updates, and the like. With the widespread use of smart parking systems, parking lot users may save money and time in finding a parking space by checking available parking spaces and information on parking prices in real time.

Recently, an online to offline (O2O) platform for parking space booking has emerged, making it easier for users to find and book parking spaces and parking prices. As an environment has been established where the users can easily access information on parking prices using the O2O platform, the price of parking permit sold through online has become a very important factor in parking space management. It is possible to manage the congestion levels and usage of parking lots by adjusting demand through pricing, such as increasing the price of parking permit to discourage demand for parking permit sales, or conversely, decreasing the price to encourage demand.

Accordingly, the present invention proposes a technology for performing a dynamic pricing strategy that enhances the use of resources and improves profits through adjusting the price of parking permit. The dynamic pricing strategy is a technique that seeks to maximize the efficient use of resources and profit through the adjustment of price-sensitive demand, in industries with very high fixed costs for resource investment and relatively small variable costs, such as the airline, hotel, and car rental industries.

Recently, with the development of machine learning/artificial intelligence technology, there has been an increase in research on using reinforcement learning, which does not require prior knowledge on data characteristics, unlike traditional techniques that assume demand distribution and the like in dynamic pricing problems. Accordingly, the present invention is to propose a technique for alleviating the congestion level of a parking lot, or improving the utilization rate of a parking space, by adjusting the parking price for each time period using the reinforcement learning, in a parking space management problem. The present invention proposes a dynamic pricing model that comprehensively considers the occupancy rate, expected demand, parking time, and the like of a parking lot using a dynamic pricing technique based on the reinforcement learning. In the present invention, a pre-sale situation is in consideration, where a customer explores a price of a parking permit using the O2O platform before visiting a parking lot, and decides whether to park or not. According to the present invention, since the customer purchases a parking permit in advance before arriving at the parking lot, there is a difference between an occasion of parking permit purchase and an occasion of actual vehicle entry, and a model that differs from the related art in consideration of this will be used.

Specifically, the present invention proposes a system, based on deep learning, that adjusts the price of parking permit sold online to minimize unoccupied spaces in a parking lot and maximize sales of a parking lot. For example, when a buyer purchases a three-hour parking permit online, comes to a parking lot, and there are no spots available, the buyer may be dissatisfied with the service. Therefore, it may be more advantageous to adjust the price to be expensive to avoid the parking lot from being full, rather than selling a lot of 3-hour parking permits at a cheap price. Therefore, the present invention is to propose a technology for dynamically determining a price for a parking permit of a specific usage period (e.g., a 3-hour permit) in a parking lot environment where parking permits of various usage periods (e.g., all-day, 6-hour permit, 3-hour permit, and the like) are usable.

A parking permit sales structure for a parking lot in consideration of the present invention is as follows. The parking permits sold are divided into a regular periodic permit and a non-regular periodic permit. The regular periodic permit is a parking permit for using a parking lot on a regular basis and has a usage period on a weekly or monthly basis. The non-regular periodic permit is a parking permit for a temporary use, with a usage period of several hours (such as 3 hours, 6 hours, and like) or one day. The non-regular periodic permit may be sold offline or through the O2O platform. Through the O2O platform online, the non-regular periodic permits such as 3-hour permit, all-day permit, and the like are sold, and the parking permit purchased online may be used on the day of purchase. According to the characteristics of online sales of the parking permit, the purchase of the parking permit and the actual entry into the parking lot will be on the same date, but there may be a difference between an occasion of parking permit purchase and an occasion of vehicle entry. In such an environment, the present invention is to propose a technology for determining a price of a parking permit with a specific usage period (e.g., a 3-hour permit) sold on the O2O platform (hereinafter referred to as an “eligible parking permit”).

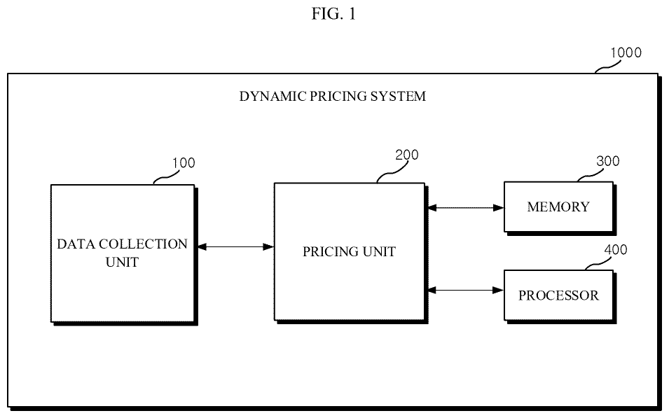

FIG. 1 is a block diagram for describing a dynamic pricing system of the present invention.

A dynamic pricing system 1000, based on a deep learning algorithm, may dynamically determine a price of a parking permit according to an operational situation of a parking lot. The dynamic pricing system 1000 may include a data collection unit 100, a pricing unit 200, a memory 300, and a processor 400. The dynamic pricing system 1000 may not include some of the constituent elements 100 to 400 illustrated in FIG. 1, and may further include constituent elements not illustrated. The dynamic pricing system 1000 may be implemented as one of a smartphone, a smartpad, a tablet PC, a notebook with a web browser, a desktop, a laptop, or the like. In addition, the dynamic pricing system 1000 may be a cloud-based application that implements the operations and functions of the constituent elements 100 to 400 through a cloud server. In this case, the dynamic pricing system 1000 may perform an operation and function of dynamically determining a price for an eligible parking permit.

The dynamic pricing system 1000 may collect situation data necessary to determine the price of the parking permit using the data collection unit 100, and may determine the price of the parking permit using the pricing unit 200. For example, the situation data may include parking permit sales volume, lead time (e.g., a time taken to arrive at a parking lot after purchasing a parking permit), parking duration, vehicle entry volume, vehicle exit volume, parking lot occupancy rate, and the like. In particular, the dynamic pricing system 1000 determines a price of the eligible parking permit (e.g., a 3-hour permit).

The memory 300 may store instructions for operating each of the constituent elements 100 to 200, as well as information on algorithms used in each of the constituent elements 100 to 200. The memory 300 may include non-volatile memory, volatile memory that is frequently accessible, and/or other various types of memory. For example, the memory 300 may include flash memory, DRAM, PRAM, or a combination thereof.

The processor 400 may execute the instructions stored in the memory to operate the respective constituent elements 100 to 200. In addition, the processor 400 may train at least one of the constituent elements 100 to 200 according to a user setting.

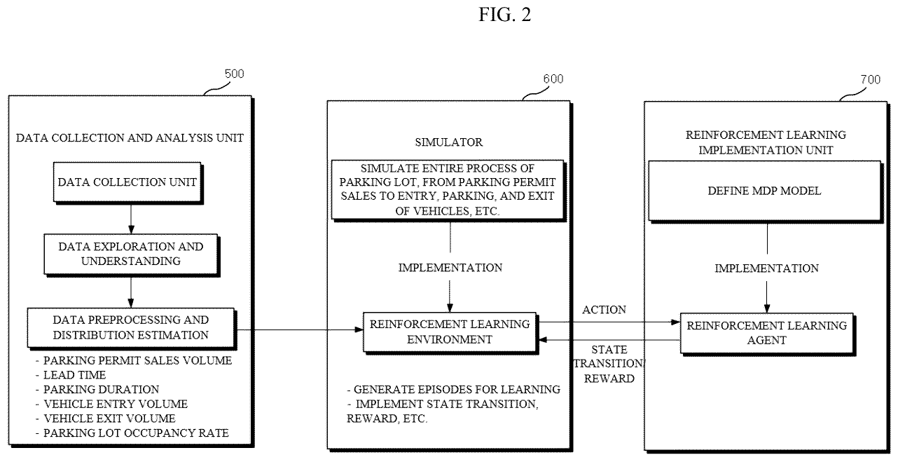

FIG. 2 is a block diagram for describing a training operation of the dynamic pricing system of the present invention.

The pricing unit 200 of the dynamic pricing system 1000 may be trained and implemented by a data collection and analysis unit 500, a simulator 600, and a reinforcement learning implementation unit 700.

The data collection and analysis unit 500 collects raw data required from at least one actual parking lot. The data collection and analysis unit 500 may process data collected through processes such as data collection, data search and understanding, data preprocessing and distribution estimation, and the like, into the form of learning data for training. Accordingly, the data may be obtained such as parking permit sales volume, lead time (e.g., a time taken to arrive at a parking lot after purchasing a parking permit), parking duration, vehicle entry volume, vehicle exit volume, parking lot occupancy rate, and the like. That is, the data collection and analysis unit 500 may preprocess the data to derive distributions on the parking permit sales volume for each time period, parking duration by vehicle, size of vehicle entry and vehicle exit, and the like.

The simulator 600 is a simulator that simulates a situation in a parking lot using the results of data analysis generated by the data collection and analysis unit 500, and generates learning data for reinforcement learning. Since data collected in an actual parking lot is not sufficient for learning, it is necessary to generate a sufficient amount of learning data through the simulator 600. Accordingly, the simulator 600 may be designed to simulate the entire process of using a parking lot, from the sale of a parking permit to entry, parking, exit, and the like. Therefore, a reinforcement learning environment is implemented, and specifically, episodes for learning are generated, state transitions, rewards, and the like may be implemented.

The reinforcement learning implementation unit 700 performs reinforcement learning according to an MDP model and a reinforcement learning procedure to determine the price of the eligible parking permit. The reinforcement learning implementation unit 700 performs the reinforcement learning based on the learning data generated by the simulator 600.

As learning is performed according to a structure as illustrated in FIG. 2, the pricing unit 200 may be implemented. To this end, first, the MDP model needs to be defined. A decision making problem of determining the price of an eligible parking permit sold online every hour for one day may be designed as a finite horizon MDP model. According to an embodiment of the present invention, the MDP model may be implemented with parameters defined as shown in Table 1 below.

TABLE 1

| Parameter | Contents |
|---|---|
| xₜ | Number of online parking permits sold at occasion t |
| nₜ | Number of parking permits sold online that are not used by |
| | occasion t after purchase. |
| ${n}_{t}^{a}$ | Number of vehicles that entered parking lot at occasion t using parking permits purchased online. |
| ${n}_{t}^{d}$ | Number of vehicles that entered and then exited parking lots using parking permit purchased online at occasion t. |
| ${o}_{t}^{a}$ | Number of vehicles entered parking lot at occasion t by means other than parking permit purchased online |
| ${o}_{t}^{d}$ | Number of vehicles that entered and then exited at occasion t by means other than parking permit purchased online |
| α | Unit penalty cost on occupancy rate above 100% |
| C | Total number of parking spaces in parking lot (capacity) |
| Kₜ | Parking lot occupancy rate at occasion t (%) |

A state Sₜ at occasion t is defined by Sₜ=<Nₜ,Kₜ,Tₜ>, which includes the number of unused parking permits Nₜ a parking lot occupancy rate Kₜ and Tₜ, which is a time period of day. The number of unused parking permits is Nₜ={nₜ₋₁, nₜ₋₂, . . . , nₜ₋ₘ}, where nₜ₋ₘ means the number of remaining parking permits that were not used by occasion t among the parking permits sold online before period m, that is, did not enter the parking lot. Kₜ is a parking lot occupancy rate at occasion t, expressed as a ratio (%) of parked vehicles to a total number of parking spaces. Tₜ is expressed in a one-hot encoding that divides 24 hours a day into four sections. For example, Tₜ=(0,1,0,0) means a section from 6 am to 12 pm, and Tₜ=(0,0,1,0) means a section from 12 pm to 6 pm.

Action aₜ∈A at occasion t is the price of an eligible parking permit sold online, representing an increment on a base price p̅. Reward rₜ at occasion for a combination of a state and an action comprises a revenue according to the sale of eligible parking permits and a penalty cost for vehicles that fail to enter the parking lot due to lack of parking spaces. In mathematical terms, this is expressed as Equation 1 below.

$${r}_{t} ( {s}_{t} , {a}_{t} ) = {p}_{t} \times {x}_{t} - α \times {[ {K}_{t} + ( {n}_{t}^{a} - {n}_{t}^{d} + {o}_{t}^{a} - {o}_{t}^{d} ) / C - 100 ]}^{+} \qquad Equation 1$$

According to Equation 1, a selling price pₜ of an eligible parking permit will be pₜ=p̅+αₜ when an action is αₜ. When a maximum occupancy rate of the parking lot exceeds 100% between occasions (t, t+1), entry is not possible, which results in additional costs, such as decreased customer satisfaction or the provision of compensation in excess of the selling price of the parking permit. Therefore, a unit penalty cost α is applied to an occupancy rate exceeding 100%.

The state transition is a stochastic process that is determined by uncertain factors such as a new parking permit sales volume, lead time (e.g., a difference between an occasion of parking permit purchase and an occasion of actual vehicle entry), and the like, and may be determined using the simulator 600. nₜ₋₂ means the number of unused parking permits that were purchased online on occasion t−2, but whose vehicle entry is not made, during the state transition from nₜ₋₂ to nₜ₋₃, the number ñₜ₋₂ of vehicles that entered the parking lot among nₜ₋₂ is determined according to a probability distribution, and the state transition becomes nₜ₋₃←nₜ₋₂−ñₜ₋₂ by subtracting ñₜ₋₂ from n₋₂. In addition, parking lot occupancy rate Kₜ during the state becomes

$${K}_{t + 1} ← {K}_{t} + ( {n}_{t}^{a} - {n}_{t}^{d} + {o}_{t}^{a} - {o}_{t}^{d} ) / C ,$$

reflecting the number of vehicles entering and exiting the parking lot, which is determined by a probability distribution.

The simulator 600 is intended to generate learning data, and is designed to simulate a vehicle entry/exit process of a parking lot, and the parking permit sales volume through online. The simulator 600 may determine the state transition and reward in the reinforcement learning process based on the vehicle entry/exit and parking permit sales volume data collected by the data collection and analysis unit 500.

First, an average sales volume, lead time distribution, and parking duration distribution of eligible parking permits for each time period were derived through exploratory analysis of the collected data to implement the simulator. The average number of vehicle entry/exit and parking duration distribution for each time period were derived for vehicles using the parking lot in other ways than using an eligible parking permit purchased online.

The probability of selling χ parking permits when the average sales volume of eligible parking permits at occasion t is λₜ may be expressed by a Poisson distribution, as shown in Equation 2.

$${f}_{t} ( x ; {λ}_{t} ) = \frac{{λ}_{t}^{x} \times {e}^{{λ}_{t}}}{x !} = {[ \overline{{λ}_{t}} \cdot e ( {p}_{t} ) ]}^{x} \times \frac{{e}^{\overline{{λ}_{t}} \cdot e ( {p}_{t} )}}{x !} \qquad Equation 2$$

In this case, the average sales volume λₜ is calculated as λₜ=λ̅ₜ̅·e(pₜ) by reflecting a change in demand for eligible parking permits according to a change in price, that is, price elasticity of demand e(pₜ), to the average sales volume λ̅ₜ̅ derived from data analysis. When the sales volume of eligible parking permits according to the price is q(pₜ), the price elasticity of demand, e(pₜ), may be calculated as a ratio of an amount of change in the price of eligible parking permits to an amount of change in the average sales volume, as shown in Equation 3.

$$e ( {p}_{t} ) = \{ \begin{matrix}\frac{Δ {q}_{t}}{Δ {p}_{t}} = \frac{q ( {p}_{t} ) - q ( \overline{p} )}{{p}_{t} - \overline{p}} = \frac{q ( {p}_{t} ) - q ( \overline{p} )}{{a}_{t}} , & {a}_{t} \neq 0 \\ 1 , & {a}_{t} = 0\end{matrix} \qquad Equation 3$$

nₜ^{a} represents the vehicle entry volume of vehicles using the eligible parking permit at occasion t. In case of the eligible parking permit, since there is a lead time, which is a difference between an occasion of parking permit purchase online and an occasion of vehicle entry into the parking lot, the vehicle entry volume is determined in consideration of the number Nₜ={nₜ₋₁, nₜ₋₂, . . . , nₜ₋ₘ} of parking permits sold online but not used. ñ_{t-τ} is the number of vehicles entered the parking lot at occasion t among the parking permits purchased prior to period τ but unused, which becomes

$${n}_{t}^{a} = {\sum }_{τ = 0}^{m} {\tilde{n}}_{t - τ} .$$

ñ_{t-τ} may be generated randomly using an empirical distribution from lead times derived from the data collected. Vehicle entry volume

$${o}_{t}^{a}$$

using other methods than the eligible parking permit may be estimated with a Poisson distribution using an average daily vehicle entry volume derived from the collection data. That is, when the vehicle entry volume for each time period is

$${λ}_{t}^{o} ,$$

a probability that the vehicle entry volume is Oₜ^{a} at occasion t becomes

$${( {λ}_{t}^{o} )}^{x} \times {e}^{- {λ}_{t}^{o}} / {o}_{t}^{a} ! .$$

After determining the vehicle entry volumes

$${n}_{t}^{a} and {o}_{t}^{a} ,$$

vehicle exit volumes

$${n}_{t}^{d} and {o}_{t}^{d}$$

for each time period may be determined by reflecting parking duration for each vehicle. The parking duration may be randomly generated using the same empirical distribution with no consideration of the type of parking permit. When maximum parking duration is h , and the number of vehicles with parking duration τ is

$$\tilde{{n}_{t - τ}^{a}} ,$$

the vehicle exit volume of vehicles that entered the parking lot using the eligible parking permit at occasion t becomes

$${n}_{t}^{d} = {\sum }_{τ = 0}^{h} \tilde{{n}_{t - τ}^{a}} .$$

Similarly, the vehicle exit volume of vehicles entered the parking lot by other methods than the eligible parking permit may be calculated as

$${o}_{t}^{d} = {\sum }_{τ = 0}^{h} \tilde{{o}_{t - τ}^{a}} .$$

In addition, using the size of vehicle entry/exit at occasion t, an occupancy rate Kₜ of the parking lot may be calculated.

The reinforcement learning implementation unit 700 may perform deep Q-network (DQN) reinforcement learning. Q-learning is a representative reinforcement learning technique that learns a Q-function, which is a value function that represents an expected value of a future reward for an action in a given state, and therefore, learns an optimal policy. The present invention uses the Q-learning as a default reinforcement learning method, but in consideration of a parking lot environment that may have a state configured in multiple dimensions and difficulty in obtaining structured information, the DQN, which is a representative model-free reinforcement learning technique, may be used. The DQN reinforcement learning estimates a value function using an artificial neural network instead of managing and learning the value function on state-action combinations in a tabular data format. The artificial neural networks according to the present invention each includes an input layer, a hidden layer, and an output layer, in which the input layer, the hidden layer, and the output layer are connected in a fully connected method, and a rectified linear unit (ReLU) activation function is used. The artificial neural network receives a state of the MDP model as input and generates a value of a value function (e.g., Q function) for each state-action combination as output.

$$\hat{Q} ( s , a ) = r ( s , a ) + γ {max}_{a} \hat{Q} ( {s}^{′} , {a}^{′} ) \qquad Equation 4$$

Equation 4 shows a learning process for a value function with a discount factor of γ. s′ means a state at next occasion, t+1, and a′ means an action at next occasion, t+1. The DQN reinforcement learning may be performed using an MSE loss function, that is, using (r(s,a)+γmaxₐ\hat{Q}(s′,a′)−\hat{Q}(s,a))² In order to improve the efficiency of learning and prevent correlation between learning samples, experience replay (ER) may be used, and the stability of learning may be improved by separating a policy network and a target network. Finally, reflecting the weight of random exploration and exploitation, a ε-greedy technique may be used in an action selection process. The ε-greedy technique allows a ratio of exploration to exploitation to be performed with variables of εto 1ε.

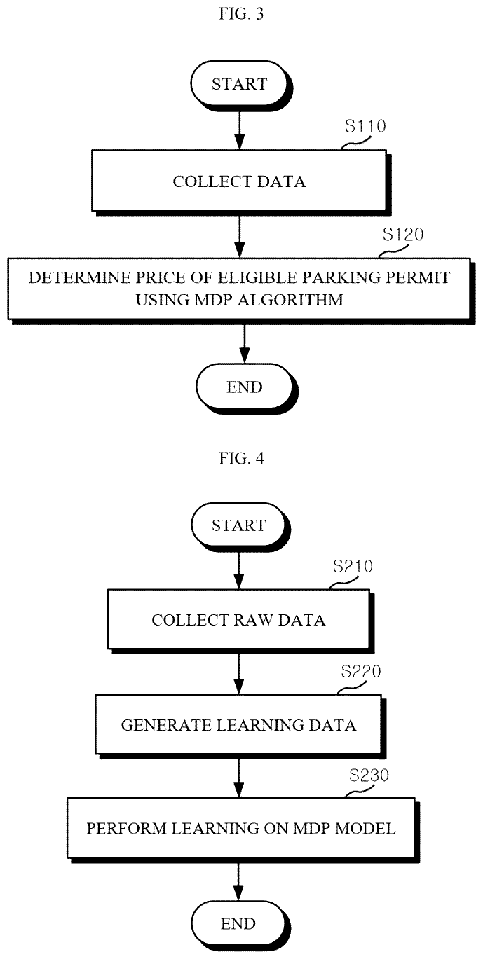

FIG. 3 is a flowchart for describing the pricing operation of the dynamic pricing system. FIG. 1 is referenced herein for the understanding of the description.

At operation S110, the dynamic pricing system 1000 collects data necessary to determine the price of the eligible parking permit. The data may include information for specifying a state at the current time, and may include, for example, at least one of the number of unused parking permits (e.g., eligible parking permits, other parking permits, and the like) sold prior to entering a current time period or a parking lot occupancy rate.

At operation S120, the dynamic pricing system 1000 determines the price of the eligible parking permit using an MDP algorithm. Here, the MDP algorithm determines action information that represents an amount of change in the price of the parking permit on the basis of state information, which is specified by a combination of the number of unused parking permits, the parking lot occupancy rate, and the current time period.

FIG. 4 is a flowchart for describing a training operation of a pricing unit of the dynamic pricing system. FIG. 2 is referenced herein for the understanding of the description.

At operation S210, the simulator 600 collects raw data. Here, the raw data may include at least one of the number of parking permits sold online for each time period, the number of parking permits sold online that were not used by each time period after purchase, the number of vehicles that entered the parking lot using the parking permit purchased online for each time period, the number of vehicles that entered and then exited the parking lot using the parking permit purchased online for each time period, the number of vehicles that entered the parking lot using a method other than the parking permit purchased online for each time period, the number of vehicles that entered and then exited the parking lot using the method other than the parking permit purchased online for each time period, or a total number of parking spaces in the parking lot.

At operation S220, the simulator 600 generates learning data. That is, the simulator 600 generates learning data to allow the MDP model for the MDP algorithm to be learned. Here, the MDP model is defined to have a state that is specified by a combination of the number of unused parking permits, the parking lot occupancy rate, and the current time period, to have a state transition based on a new parking permit sales volume, lead time, and vehicle exit volume during a time period change, and to determine a reward corresponding to an action that represents an amount of change in the price of a parking permit and the state on the basis of the price of the parking permit reflecting the amount of change in the price and a penalty cost given according to a lack of parking spaces.

According to an embodiment of the present invention, the simulator 600 may, in order to have a state transition from a first state corresponding to a first time period to a second state corresponding to a second time period, determine the number of parking permits used during the first time period among unused parking permits of the first state, the number of vehicles that exited the parking lot during the first time period, and the number of parking permits that were sold during the first time period, and determine the second state on the basis of the number of parking permits used, the number of vehicles that exited the parking lot, and the number of parking permits that were sold. Here, each of the number of parking permits used and the number of parking permits sold may be determined according to a set probability distribution.

The number of parking permits sold is determined on the basis of a Poisson distribution based on an estimated value of an average parking permit sales volume for each time period. Here, the estimated value of the average parking permit sales volume for each time period may be determined by a product of an average parking permit sales volume derived from the raw data and price elasticity of demand, which indicates a change in demand for parking permits according to a change in price.

The number of parking permits used may include a sum of the number of vehicles that entered the parking lot using the parking permit and the number of vehicles that entered the parking lot using other parking permits. Here, the number of vehicles exited may include a sum of the number of vehicles entered using the parking permit and then exited during the first time period and the number of vehicles entered using other parking permits and then exited during the first time period.

The number of vehicles entered using the parking permit may be determined on the basis of the number of parking permits sold and an expected value of a lead time. Here, the estimated value of the lead time may be determined using an empirical distribution function, from a lead time derived from the raw data. In addition, the number of vehicles entered using other parking permits may be determined on the basis of a Poisson distribution based on an average vehicle entry volume derived from the raw data.

At operation S230, the reinforcement learning implementation unit 700 performs learning for the MDP model. That is, the reinforcement learning implementation unit 700 trains the MDP model using learning data. According to an embodiment of the present invention, the reinforcement learning implementation unit 700 may estimate a value function representing an expected value of a reward for an action determined at a given state of the MDP model using an artificial neural network. Here, the artificial neural network receives a state of the MDP model as input and generates a value function corresponding to a combination of the state and the action as output. In addition, the reinforcement learning implementation unit 700 may perform learning while selecting an action for the MDP model using the ε-greedy technique of performing a ratio of exploration to exploitation with variables of εto 1-ε.

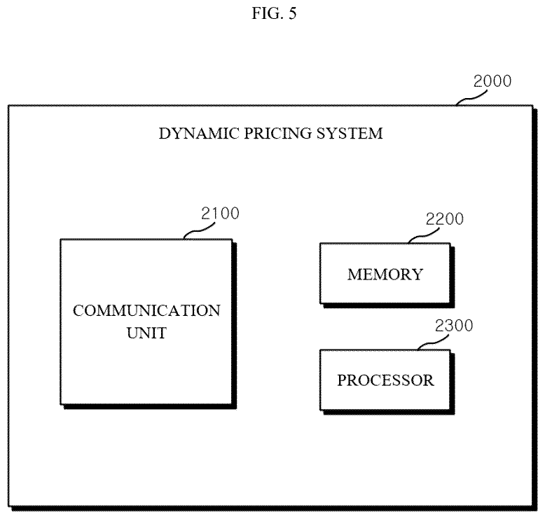

FIG. 5 is a block diagram illustrating a configuration of the dynamic pricing system according to an embodiment of the present invention.

A dynamic pricing system 2000 illustrated in FIG. 5 may perform substantially the same operations as the dynamic pricing system 1000 in FIG. 1. The dynamic pricing system 2000 may include a communication unit 2100, a memory 2200, and a processor 2300. The dynamic pricing system 2000 may be implemented as an embedded board, a smartphone, a tablet PC, a PC, a smart TV, a cell phone, a personal digital assistant (PDA), a laptop, a vehicle, and other mobile or non-mobile computing devices, but is not limited thereto.

The communication unit 2100 may include one or more constituent elements that enable the dynamic pricing system 2000 to communicate with an external electronic device. The communication unit 2100 may include a short-range wireless communication unit (not illustrated), a mobile communication unit (not illustrated), and a broadcast reception unit (not illustrated). The short-range wireless communication unit may include a Bluetooth communication unit, a Bluetooth low energy (BLE) communication unit, a near field communication unit, a WLAN (Wi-Fi) communication unit, a Zigbee communication unit, an infrared data association (IrDA) communication unit, a Wi-Fi Direct (WFD) communication unit, an ultra wideband (UWB) communication unit, an Ant+communication unit, and the like, but is not limited thereto. The mobile communication unit transmits and receives a wireless signal to and from at least one of a base station, an external terminal, or a server in a mobile communication network. Here, the wireless signal may include a voice call signal, a video call signal, or various forms of data according to transmission or reception of text/multimedia messages. The broadcast reception unit receives a broadcast signal and/or information related to broadcasting from an external source through a broadcast channel. The broadcast channel may include a satellite channel or a terrestrial channel. Depending on an implementation example, the communication unit 2100 may not include the broadcast reception unit. The dynamic pricing system 2000 may also receive order logs for existing items, attribute information on the existing items, and attribute information on new items from an external device through the communication unit 2100.

The memory 2200 may store a program for processing and controlling the processor 2300, and may store data that is input to the dynamic pricing system 2000 or output from the dynamic pricing system 2000. In addition, the memory 2200 may store algorithms for implementing the clustering model, the bidirectional RNN model, and the MCMF model used in the dynamic pricing system 2000. In addition, the memory 2200 may store the order logs for the existing items, the attribute information on the existing items, and the attribute information on the new items.

The memory 2200 may include at least one type of storage medium among a flash memory type, a hard disk type, a multimedia card micro type, a card type of memory (e.g., SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk.

The processor 2300 may generally control an overall operation of the dynamic pricing system 2000. The processor 2300 may perform the operations of the dynamic pricing system 200 described with reference to FIGS. 1 to 5, and/or provide services provided by the dynamic pricing system 200, by executing the programs stored in the memory 2200. The processor 2300 may be implemented as a central processing unit (CPU), or a processing unit optimized for operating a machine learning model, such as a graphic processing unit (GPU), a neural processing unit (NPU), or the like. The processor 2300 may implement the deep learning-based model described with reference to FIG. 1 using a language such as Java, C/C++, python, or R, and an implementation language such as tensorflow, Keras, or Pytorch based on python.

The descriptions above are specific embodiments for carrying out the present invention. The present invention includes not only the embodiments described above, but also embodiments that can be simply modified in design or easily modified. In addition, the present invention includes technologies that can be easily modified and carried out using the embodiments. Therefore, the scope of the present invention should not be limited to the described embodiments, and should be defined by not only the claims to be described below, but also those equivalents to the claims.

1. A dynamic pricing system comprising:
a data collection unit configured to collect real data from a sensor deployed in a parking lot to determine a price of a specific parking permit;
a pricing unit configured to determine the price of the specific parking permit from the real data, using a Markov Decision Process (MDP) algorithm;
a simulator configured to generate learning data for training an MDP model used in the MDP algorithm;
a reinforcement learning implementation unit configured to train the MDP model using the learning data;
a memory configured to store instructions to operate the data collection unit and the pricing unit; and
a processor configured to execute the instructions stored in the memory to operate the data collection unit and the pricing unit,
wherein the MDP algorithm determines, on the basis of state information specified by a combination of the number of unused parking permits after purchase, a parking lot occupancy rate, and a current time period, action information that represents an amount of change in price of the specific parking permit,
wherein the pricing unit determines the price of the specific parking permit by summing the amount of change in price specified by the action information determined by the MDP algorithm to a base price of the specific parking permit,
wherein the pricing unit is configured to apply the determined price dynamically to an online parking permit reservation interface, enabling automatic pricing updates in response to conditions of the parking lot in real time,
wherein the MDP model is defined to have the state information specified by a combination of (i) the number of unused parking permits, (ii) the parking lot occupancy rate, and (iii) the current time period associated with a first state,
wherein the MDP model is further configured to perform a state transition to a second state based on (i) a number of sold parking permits, (ii) a lead time, and (iii) a volume of vehicle exits during the first state,
wherein the MDP model is further configured to determine the action information and a reward value corresponding to a state, based on (i) the price of the specific parking permit reflecting the amount of change and (ii) a penalty cost associated with a shortage of available parking spaces,
wherein the reinforcement learning implementation unit estimates a value function representing an expected value of a reward for an action determined in a given state of the MDP model using an artificial neural network, and
wherein the artificial neural network receives a state of the MDP model as input and generates a value function corresponding to a combination of the state and the action as output.

2. (canceled)

3. The dynamic pricing system of claim 1, wherein the simulator generates the learning data using raw data, and
wherein the raw data includes at least one of the number of sold parking permits, the number of unused parking permits after purchase, a number of vehicles that entered the parking lot using the sold parking permits, a number of vehicles that entered and then exited the parking lot using the sold parking permits, a number of vehicles that entered the parking lot using a method other than the sold parking permits, a number of vehicles that entered and then exited the parking lot using the method other than the sold parking permits, or a total number of parking spaces in the parking lot.

4. The dynamic pricing system of claim 3, wherein the simulator, in order to have a state transition from the first state corresponding to a first time period to the second state corresponding to a second time period, determines a number of used parking permits during the first time period, the number of vehicles that exited the parking lot during the first time period, and the number of sold parking permits during the first time period, and determines the second state on the basis of the number of used parking permits, the number of vehicles that exited the parking lot, and the number of sold parking permits, and
wherein each of the number of used parking permits and the number of sold parking permits sold is determined by a set probability distribution.

5. The dynamic pricing system of claim 4, wherein the number of sold parking permits is determined on the basis of a Poisson distribution based on an estimated value of an average parking permit sales volume for each time period, and
wherein the estimated value of the average parking permit sales volume for each time period is determined by a product of an average parking permit sales volume derived from the raw data and price elasticity of demand, which indicates a change in demand for the specific parking permits according to a change in price.

6. The dynamic pricing system of claim 4, wherein the number of used parking permits includes a sum of the number of vehicles entered using the sold parking permits and the number of vehicles entered using the method other than the sold parking permits, and
wherein the number of vehicles exited includes a sum of the number of vehicles entered using the sold parking permits and then exited during the first time period and the number of vehicles entered using the method other than the sold parking permits and then exited during the first time period.

7. The dynamic pricing system of claim 6, wherein the number of vehicles entered using the sold parking permits is determined on the basis of the number of sold parking permits and an estimated lead time, and
wherein the estimated lead time is determined from the lead time derived from the raw data, using an empirical distribution function.

8. The dynamic pricing system of claim 6, wherein the number of vehicles entered using the method other than the sold parking permits is determined on the basis of a Poisson distribution based on an average vehicle entry volume derived from the raw data.

9. (canceled)

10. The dynamic pricing system of claim 1, wherein the reinforcement learning implementation unit selects and learns an action for the MDP model using a ε-greedy technique of performing a ratio of exploration to exploitation with variables of & to 1-ε.
